(19) United States
(12) Patent Application Publication
(10) Pub. No.: US 2026/0192692 A1
(43) Pub. Date: Jul. 9, 2026

(54) CHARGING APPARATUS AND METHOD USING SEPARATE TYPE CHARGING CABLE, SEPARATE TYPE CHARGING CONNECTOR, AND STORAGE MEDIUM

(71) Applicants: HYUNDAI MOTOR COMPANY, SEOUL (KR); KIA CORPORATION, SEOUL (KR)

(72) Inventor: Jun Sub Kim, Hwaseong-si (KR)

(73) Assignees: HYUNDAI MOTOR COMPANY, SEOUL (KR); KIA CORPORATION, SEOUL (KR)

(21) Appl. No.: 19/228,018

(22) Filed: Jun. 4, 2025

(30) Foreign Application Priority Data
Jan. 8, 2025 (KR) 10-2025-0002993

(51) Int. Cl. B60L 53/35; B60L 53/16; B60L 53/18; B60L 53/30; B60L 53/62

(52) U.S. Cl. CPC B60L 53/35; B60L 53/16; B60L 53/18; B60L 53/305; B60L 53/62

(57) ABSTRACT

A charging apparatus includes a charger providing charging power, a separate type charging cable that is connected to the charger and transmits the charging power, a wireless communication unit wirelessly communicating with a separate type charging connector which can be connected to, and separated from, the separate type charging cable, and a controller controlling movement of the separate type charging cable to a position of the separate type charging connector based on a wireless communication result of the wireless communication unit.

### CROSS REFERENCE TO RELATED APPLICATIONS

This application claims benefit of priority to Korean Patent Application No. 10-2025-0002993 filed on January 8, 2025 in the Korean Intellectual Property Office, the disclosure of which is incorporated herein by reference in its entirety.

### BACKGROUND

### 1. FIELD

The present disclosure relates to a charging apparatus and method using a separate type charging cable, a separate type charging connector, and a storage medium.

### 2. DESCRIPTION OF RELATED ART

Eco-friendly vehicles refer to low-carbon, high-fuel-efficiency vehicles using a novel power source, such as a battery or a fuel cell, ultra-high-efficiency novel combustion technology, and having low emissions of existing air pollutants and greenhouse gases and excellent fuel efficiency. Such eco-friendly vehicles are largely divided into electric-based vehicles and engine-based vehicles, and in particular, electric-based vehicles are known as xEVs. xEVs include hybrid electric vehicles (HEVs), plug-in hybrid vehicles (PHEVs), electric vehicles (EVs), and fuel cell electric vehicles (FCEVs) and require periodic charging from a charging apparatus. Recently, in addition to vehicles that move on the ground, air mobility devices moving in the air and urban mobility devices moving in other types of spaces (e.g., underground, underwater) have also been actively studied. Therefore, various types of mobility device devices, including vehicles (xEVs, etc.), are gradually experiencing demand for charging.

As increased performance (e.g., a driving distance per charge) of mobility devices has been required, the battery capacity in mobility devices has also gradually increased. As the battery capacity is higher, a battery charging time may take longer. Accordingly, voltage and current of charging power of charging apparatuses have also been gradually increased to reduce charging times.

As the voltage and current of charging power of charging apparatuses increase (or a charging speed increases), charging cables may require higher insulation performance and/or lower energy loss. As a result, charging cables may have a thicker diameter or a heavier weight.

### SUMMARY

As charging cables become larger or heavier, it may become more inefficient (e.g., greater force may be required from the user) or more unsafe (e.g., causing a safety accident during movement or causing a safety accident during connection) for a user to manually move a charging cable for mobility device charging.

An aspect of the present disclosure is to provide a charging apparatus and method using a separate type charging cable, a separate type charging connector, and a storage medium, by which a user may easily connect the separate type charging cable to the separate type charging connector without manually moving the separate type charging cable when bringing the separate type charging connector into proximity with the charging apparatus for mobility device charging, and inefficiency (e.g., requiring a large amount of force from the user) or instability (e.g., causing a safety accident during movement or causing a safety accident during connection) due to manual movement of the separate type charging cable may be prevented.

According to an aspect of the present disclosure, a charging apparatus includes a charger providing charging power, a separate type charging cable that is connected to the charger and transmits the charging power, a wireless communication unit wirelessly communicating with a separate type charging connector which can be connected to, and separated from, the separate type charging cable, and a controller controlling movement of the separate type charging cable to a position of the separate type charging connector based on a wireless communication result of the wireless communication unit.

The controller may control movement of one end of the separate type charging cable to a position corresponding to coordinates of the separate type charging connector on a ground based on the wireless communication result of the wireless communication unit.

The controller may control descent of the separate type charging cable so that one end of the separate type charging cable moves to a position corresponding to the coordinates and then is drawn out toward the ground.

The charger may include a charger body disposed on the ground and a ceiling portion forming a layer at one end of the charger body, the wireless communication unit may include three wireless communication beacons arranged at three different points on the ceiling portion, and the controller may measure the coordinates based on triangulation of received signal strength indicators of the three wireless communication beacons.

The controller, after controlling the movement of the separate type charging cable, may monitor connection between the separate type charging cable and the separate type charging connector and control switching whether the charger provides the charging power to the separate type charging cable according to a change in a connection monitoring result.

The separate type charging cable may include a first charging path for charging a battery within the mobility device and a second charging path for charging a battery within the separate type charging connector.

The charging apparatus may further include the separate type charging connector wherein the separate type charging connector includes a mobility connection end configured to be connected to, and separated from, the mobility device, a cable connection end configured to be connected to and separated from one end of the separate type charging cable, and a body including a battery in the separate type charging connector and electrically connecting the mobility connection end and the cable connection end, wherein the body includes a wireless communication module receiving operating power from the battery in the separate type charging connector and wirelessly communicating with the wireless communication unit.

The separate type charging connector may further include an input switch disposed at the cable connection end and receiving an input, and the body may switch whether to electrically connect one end of the separate type charging cable to the cable connection end according to the input received by the input switch.

The body may switch whether to physically separate one end of the separate type charging cable and the cable connection end according to the input received by the input switch.

According to another aspect of the present disclosure, a separate type charging connector includes a mobility connection end configured to can be connected to and separated from the mobility device, a cable connection end configured to be connected to and separated from one end of a separate type charging cable of a charging apparatus; and a body electrically connected between the mobility connection end and the cable connection end, wherein the body includes a wireless communication module wirelessly communicating with the charging apparatus.

The body may further include a battery electrically connected to the cable connection end, and the battery may provide operating power to the wireless communication module.

The wireless communication module of the body may wirelessly communicate with the charging apparatus to support measurement of a received signal strength indicator for the body of the charging apparatus.

The separate type charging connector may further include an input switch disposed at the cable connection end and receiving an input, wherein the body switches whether to electrically connect one end of the separate type charging cable and the cable connection end according to the input received by the input switch.

The body may switch whether to physically separate one end of the separate type charging cable and the cable connection end according to the input received by the input switch.

The body may include a first charging path between the charging apparatus and the mobility device and a communication path between the charging apparatus and the mobility device and switch whether to electrically connect the communication path according to the input received by the input switch.

According to another aspect of the present disclosure, a charging method using a separate type charging cable includes measuring a position of a separate type charging connector by wirelessly communicating with the separate type charging connector which can be connected to, and separated from, a separate type charging cable; controlling movement of the separate type charging cable to the position of the separate type charging connector, and controlling charging of the mobility device after the separate type charging connector is electrically connected between the separate type charging cable and the mobility device.

The measuring may include measuring coordinates of the separate type charging connector on a ground based on triangulation of received signal strength indicators of three wireless communication beacons arranged at three different points.

The controlling of the movement may include controlling the movement of one end of the separate type charging cable to a position corresponding to the coordinates, and controlling descent of the separate type charging cable so that the one end of the separate type charging cable is drawn out toward the ground after moving to the position corresponding to the coordinates.

The controlling of the charging may include monitoring connection between the separate type charging cable and the separate type charging connector after controlling the movement of the separate type charging cable, and controlling switching whether to charge the mobility device according to a change in a connection monitoring result.

According to another aspect of the present disclosure, there is provided a storage medium on which one or more programs including instructions for executing the charging method using a separate type charging cable are recorded.

### BRIEF DESCRIPTION OF THE FIGURES

The above and other aspects, features, and advantages of the present disclosure will be more clearly understood from the following detailed description, taken in conjunction with the accompanying drawings, in which:

FIGS. 1 and 2 are diagrams illustrating a charging apparatus using a separate type charging cable and a separate type charging connector according to an embodiment of the present disclosure;

FIG. 3 is a diagram illustrating that a charging apparatus and method using a separate type charging cable measure a position of a separate type charging connector based on triangulation according to an embodiment of the present disclosure;

FIG. 4 is a flowchart illustrating a charging method using a separate type charging cable according to an embodiment of the present disclosure;

FIG. 5 is a diagram illustrating that a separate type charging connector is connected to a separate type charging cable according to an embodiment of the present disclosure;

FIG. 6 is a circuit diagram illustrating a charging apparatus using a separate type charging cable and a separate type charging connector according to an embodiment of the present disclosure;

FIG. 7 is a diagram illustrating a cable connection end of a separate type charging connector and one end of a separate type charging cable according to an embodiment of the present disclosure;

FIGS. 8A, 8B, and 8C are diagrams illustrating a mobility connection end of a separate type charging connector according to an embodiment of the present disclosure; and

FIG. 9 is a block diagram illustrating that a controller of a charging apparatus and method using a separate type charging cable is implemented as a computing device according to an embodiment of the present disclosure.

### DETAILED DESCRIPTION

While the present disclosure may be modified in various ways and take on various alternative forms, specific embodiments thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms used herein to describe embodiments of the present disclosure are not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

In this specification, mobilities and mobility devices (including electric vehicles) refer to a variety of vehicles that move transported objects, such as people, animals, or goods, from a starting point to a destination. These vehicles are not limited to vehicles that run on roads or tracks.

Hereinafter, embodiment of the present disclosure will be described with reference to the accompanying drawings.

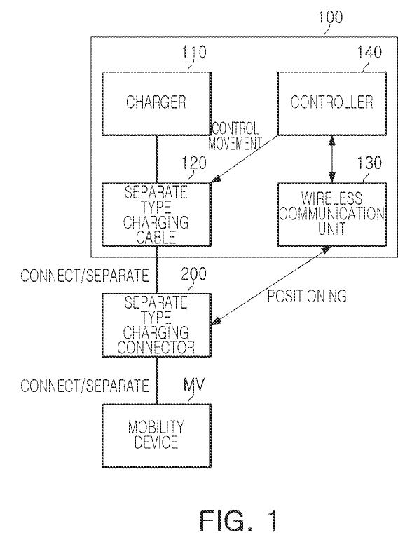

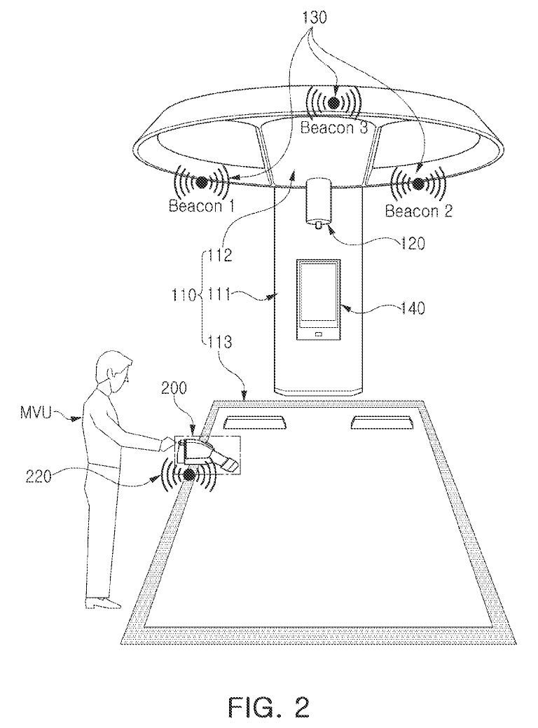

Referring to FIGS. 1 and 2, a charging apparatus 100 using a separate type charging cable according to an embodiment of the present disclosure may include a charger 110, a separate type charging cable 120, a wireless communication unit 130, and a controller 140. The separate type charging connector 200 may be included in the charging apparatus 100 or may be provided separately from the charging apparatus 100.

For example, during time other than charging time, the separate type charging connector 200 may be disposed on a mobility device MV by a mobility device user MVU of the mobility device MV or may be provided on the charging apparatus 100 away from the mobility device user MVU. The mobility device user MVU may bring the separate type charging connector 200 into proximity with the charging apparatus 100 for charging the mobility device MV.

The charger 110 may provide charging power. For example, a charger body 111 of the charger 110 may receive AC power from an external power grid or an external energy storage system and may include a converter for converting the AC power into DC power. Alternatively, the charger body 111 of the charger 110 may include an energy storage system (e.g., a large battery system) for outputting the stored DC power.

The charger 110 may charge the mobility device MV with the DC power as charging power. As voltage and current of the charging power are higher, the charging speed of the charger 110 become faster. In order to improve a driving distance of the mobility device MV, the capacity of a battery in the mobility device MV may be required to be high, and the charging speed of the charger 110 may also be required to be high.

The separate type charging cable 120 may be connected to the charger 110 to transmit the charging power. As the voltage and current of the charging power source increase, the separate type charging cable 120 may require higher insulation performance and/or lower energy loss. Accordingly, the separate type charging cable 120 may have a thicker diameter or a heavier weight.

As the separate type charging cable 120 becomes larger or heavier, it may become more inefficient (e.g., greater force is required from the mobility device user MVU) or more unsafe (e.g., causing a safety accident during movement or causing a safety accident during connection) for the mobility device user MVU to manually move the separate type charging cable 120 for mobility device MV charging.

The detachable nature of the separate type charging cable 120 may mean that the separate type charging cable 120 is separated from the separate type charging connector 200 at times other than charging. The separate type charging cable 120 may be connected to the separate type charging connector 200 immediately before charging and may be separated from the separate type charging connector 200 again after charging is completed.

The wireless communication unit 130 may communicate wirelessly (e.g., short-range wireless communication and/or long-range wireless communication) with the separate type charging connector 200 that may be connected to, and separated from, the separate type charging cable 120. The controller 140 may control movement of the separate type charging cable 120 to a location of the separate type charging connector 200 based on a wireless communication result of the wireless communication unit 130.

Accordingly, when the mobility device user MVU brings the separate type charging connector 200 into proximity with the charging apparatus 100 to charge the mobility device MV, the separate type charging cable 120 may be easily connected to the separate type charging connector 200 without manually moving the separate type charging cable 120, and inefficiency (e.g., requiring a large force from the mobility device user MVU) or instability (e.g., causing a safety accident during movement or causing a safety accident during connection) due to manual movement of the separate type charging cable 120 may be prevented.

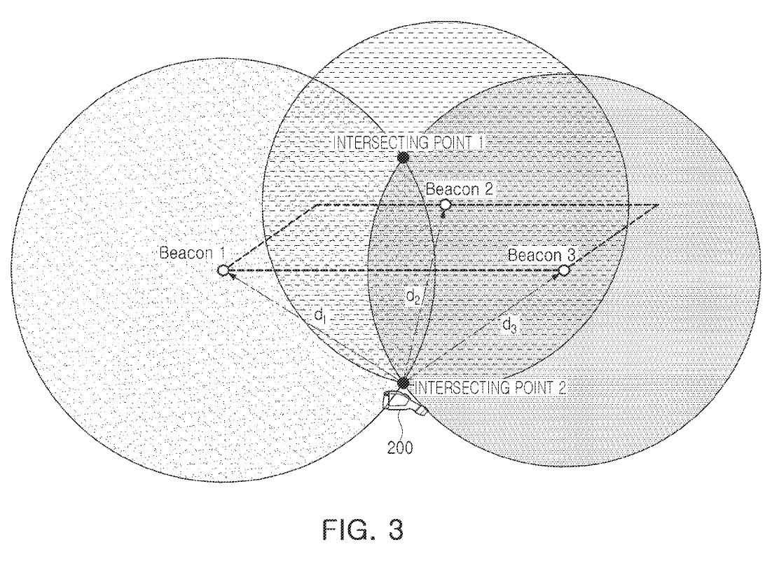

Referring to FIGS. 2 and 3, the charger 110 may include at least one of the charger body 111, a ceiling portion 112, and a ground 113. The ground 113 may provide a parking space for the mobility device MV.

The charger body 111 may be disposed on the ground 113. For example, the charger body 111 may have a columnar structure and provide a space in which the controller 140 is disposed. For example, at least a portion (e.g., input/output device) of the controller 140 may be disposed outside the charger body 111, and the rest of the controller 140 may be embedded in the charger body 111. Depending on the design, the controller 140 may be disposed in the ceiling portion 112.

The ceiling portion 112 may form a layer at one end of the charger body 111. The fact that the ceiling portion 112 forms a layer may mean that the ceiling portion 112 is structured to be generally parallel to the ground 113. For example, the ceiling portion 112 may have an internal space (e.g., a rail) accommodating the separate type charging cable 120 and may have a movable (and/or retractable) extraction hole through which one end of the separate type charging cable 120 is drawn out.

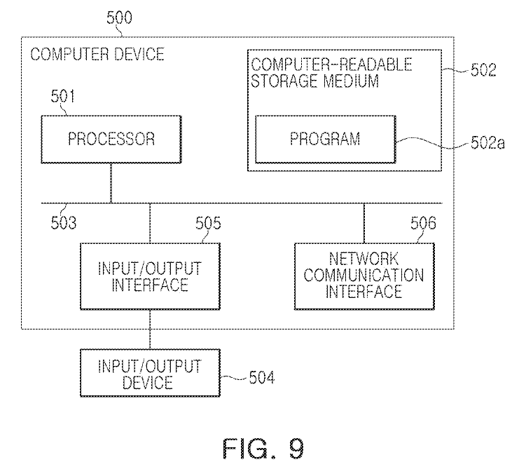

The wireless communication unit 130 may include three wireless communication beacons Beacon1, Beacon2, and Beacon3 positioned at three different points in the ceiling portion 112. For example, the three wireless communication beacons Beacon1, Beacon2, and Beacon3 may be beacons of Bluetooth®, but are not limited thereto, and may be beacons of any one of the implementable communication standards of a network communication interface 506 of FIG. 9.

Since the ceiling portion 112 may form a layer parallel to the ground, positions of the three wireless communication beacons Beacon1, Beacon2, and Beacon3 in the gravity direction may be the same. Therefore, a position of the separate type charging connector 200 in the gravity direction may not be considered.

For example, the wireless communication unit 130 may periodically remotely transmit a detection signal to the separate type charging connector 200, and the separate type charging connector 200 may remotely transmit a response signal with respect to the detection signal to the wireless communication unit 130 when it is close enough to the wireless communication unit 130 (when the intensity of the detection signal is sufficiently greater than noise).

The response signal may be attenuated in proportion to a propagation length while being propagated in the air. As the distance to the separate type charging connector 200 from each of the three wireless communication beacons Beacon1, Beacon2, and Beacon3 is longer, the intensity of the response signal received from each of the three wireless communication beacons Beacon1, Beacon2, and Beacon3 may decrease.

The controller 140 may measure horizontal two-dimensional coordinates of the separate type charging connector 200 based on triangulation of received signal strength indicators of the three wireless communication beacons Beacon1, Beacon2, and Beacon3. The controller 140 may convert the received signal strength indicators into three pieces of distance information d1, d2, and d3 required for the triangulation and may generate three circles respectively having three radii corresponding to the three pieces of distance information d1, d2, and d3. The controller 140 may set the center positions of the three circles to the positions of the three wireless communication beacons Beacon1, Beacon2, and Beacon3, generate two intersecting points (INTERSECTING POINT 1 and INTERSECTING POINT 2) of the three circles, and generate information that an intersecting point closer to the ground 113 among the two intersecting points is the position (horizontal coordinate) of the separate type charging connector 200.

The controller 140 may control the movement of one end of the separate type charging cable 120 to the position of the separate type charging connector 200 corresponding to the coordinates on the ground 113 based on the wireless communication result (e.g., triangulation result) of the wireless communication unit 130. The position corresponding to the coordinates may be a position overlapping the coordinates in the gravity direction and may be a position closer to the coordinates than before the movement.

For example, the ceiling portion 112 may be implemented in a circular shape, and the separate type charging cable 120 may be disposed in the internal space (e.g., a rail) of the ceiling portion 112 as a winding structure surrounding the center of the ceiling portion 112. The controller 140 may control the movement of the separate type charging cable 120 (e.g., movement along the guide of the rail) by applying force in a winding direction to the separate type charging cable 120. For example, the controller 140 may include an actuator for forming the force.

The controller 140 may control the descent of the separate type charging cable 120 so that one end of the separate type charging cable 120 is drawn out toward the ground 113 after moving to the position corresponding to the coordinates. Accordingly, one end of the separate type charging cable 120 may be brought closer to the separate type charging connector 200, and the mobility device user MVU may connect the separate type charging cable 120 to the separate type charging connector 200 without manually moving the separate type charging cable 120.

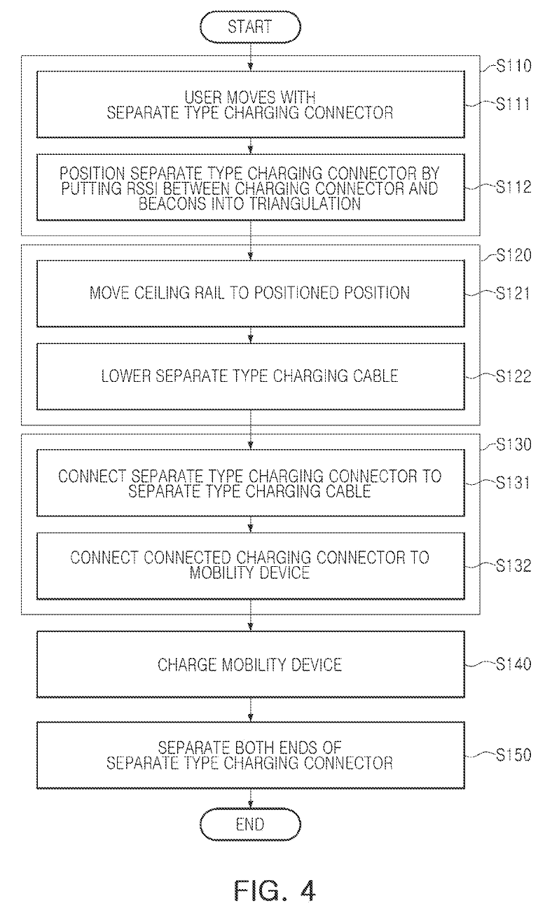

Referring to FIGS. 1 and 4, a charging method using a separate type charging cable according to an embodiment of the present disclosure may be executed by the controller 140 and includes an operation (S110) of wirelessly communicating with the separate type charging connector 200 capable of connecting to and separating from the separate type charging cable 120 to measure the position of the separate type charging connector 200; an operation (S120) of controlling movement of the separate type charging cable 120 to the position of the separate type charging connector 200; and an operation (S140) of controlling charging for the mobility device MV after the separate type charging connector 200 is electrically connected between the separate type charging cable 120 and the mobility device MV (S130).

Referring to FIGS. 2 and 4, the measuring operation (S110) may include an operation (S111) in which the mobility device user MVU moves with the separate type charging connector 200 and an operation (S112) in which coordinates of the separate type charging connector 200 on the ground 113 are measured based on triangulation of received signal strength indicators (RSSI) of three wireless communication beacons Beacon1, Beacon2, and Beacon3 arranged at three different points.

The movement controlling operation (S120) may include controlling the movement of one end of the separate type charging cable 120 to a position corresponding to the coordinates (S121) and controlling the descent of the separate type charging cable 120 so that one end of the separate type charging cable 120 is drawn out toward the ground 113 after one end of the separate type charging cable 120 moves to the position corresponding to the coordinates (S122).

The operation (S130) of controlling charging may include monitoring the connection (S131) between the separate type charging cable 120 and the separate type charging connector 200 after controlling the movement of the separate type charging cable 120 and controlling switching whether to charge the mobility device MV according to a change in the connection monitoring result.

Depending on the design, the connection monitoring may further include monitoring the connection (S132) of the separate type charging connector 200 to the mobility device MV and may also include monitoring separation (S150) of both ends (cable connection end and mobility connection end) of the separate type charging connector 200 after charging is completed. For example, when the separate type charging cable 120 is connected to the separate type charging connector 200 and the separate type charging connector 200 is connected to the mobility device MV, the controller 140 may automatically control the start of charging. For example, when the separate type charging cable 120 is separated from the separate type charging connector 200 and the separate type charging connector 200 is separated from the mobility device MV, the controller 140 may automatically control termination of charging.

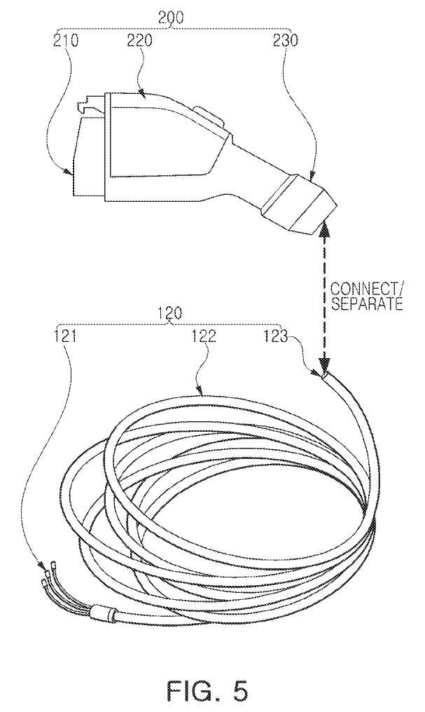

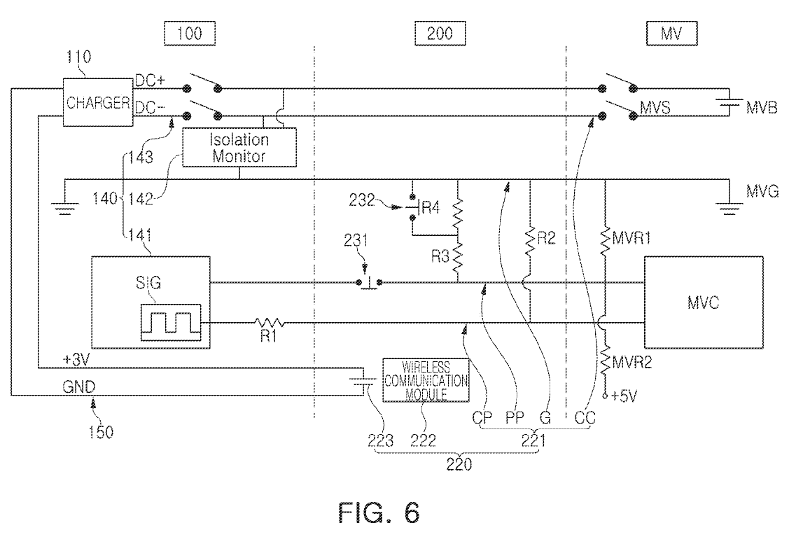

Referring to FIGS. 5 and 6, the separate type charging connector 200 according to an embodiment of the present disclosure may include a mobility connection end 210, a cable connection end 230, and a body 220. The separate type charging cable 120 may include a charging unit 121, a cable body 122, and an end 123.

The mobility connection end 210 may be connected to and separated from the mobility device MV, and the cable connection end 230 may be connected to and separated from the end 123 of the separate type charging cable 120. Meanwhile, the charging unit 121 may be fixedly connected to the charger (110 of FIG. 2). The criterion for being able to be connected and separated may be a user (MVU of FIG. 2) who does not use a connection/separation tool.

The body 220 may include a battery 223 in the separate type charging connector 200 and may electrically connect the mobility connection end 210 to the cable connection end 230. The body 220 may include a wireless communication module 222 receiving operating power from the battery 223 in the separate type charging connector 200 and communicating wirelessly with the charging apparatus 100. The wireless communication module 222 of the body 220 may wirelessly communicate with the charging apparatus 100 to support a received signal strength indicator for the body 220 of the charging apparatus 100. For example, the wireless communication module 222 comprises an antenna configured to transmit and/or receive radio frequency signals and/or an integrated circuit (e.g., a semiconductor chip) configured to process the radio frequency signals.

The battery 223 may be electrically connected to the cable terminal 230 and electrically separated from the mobility device terminal 210. The separate type charging cable 120 connected to the separate type charging connector 200 may include a first charging path CC for charging the battery MVB in the mobility device MV and a second charging path 150 for charging the battery 223 in the separate type charging connector 200.

Accordingly, the battery 223 may be charged from the charger (110 of FIG. 2) through the separate type charging cable 120. Depending on the design, the battery 223 may also be implemented as a non-rechargeable replaceable battery.

The separate type charging connector 200 may include a plurality of electrical connection paths 221, and the plurality of electrical connection paths 221 may include a first charging path CC, communication paths CP and PP, and a ground path G. The first charging path CC may be a path by which a direct current voltage (DC+, DC-) is applied to the battery MVB.

The controller 140 may control the movement of the separate type charging cable 120 and then monitor (142) the connection between the separate type charging cable 120 and the separate type charging connector 200 and control the charger 110 to switch (143) whether to provide charging power to the separate type charging cable 120 based on a change in the connection monitoring result. Accordingly, the charger 110 may automatically charge the battery MVB and/or the battery 223 simultaneously with the connection between the separate type charging cable 120 and the separate type charging connector 200.

For example, monitoring (142) may be implemented by monitoring whether a direct current voltage (DC+, DC-) is applied, and switching (143) may be implemented by switching whether a relay is turned on or off. For example, the communication unit 141 of the controller 140 may communicate (e.g., power line communication) with the communication unit MVC of the mobility device MV by transmitting a signal SIG to the communication unit MVC of the mobility device MV through the communication paths CP and PP. The mobility device MV may switch the switch MVS ON/OFF based on a communication result of the communication unit MVC.

A plurality of resistors R1, R2, R3, and R4 of the separate type charging connector 200, a plurality of resistors MVR1 and MVR2 of the mobility device MV, the ground path G, and power (e.g., +5 V, +3 V) may form a voltage/current bias of the communication paths CP and PP. The separate type charging connector 200 may change the voltage/current bias according to an input received by an input switch 232.

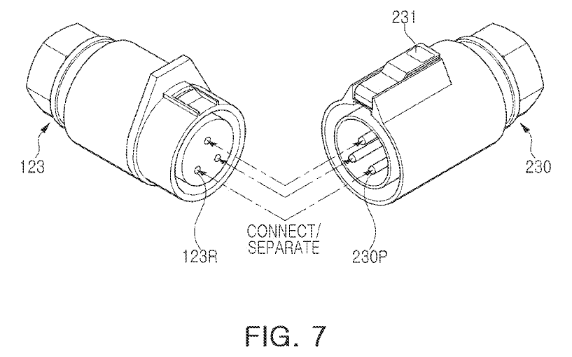

Referring to FIGS. 5 to 7, the separate type charging connector 200 may further include an input switch 231 and 232 disposed at the cable connection end 230 to receive an input, and the body 220 may switch whether to electrically connect one end of the separate type charging cable 120 and the cable connection end 230 according to the input received by the input switch 231. Therefore, a safety accident due to DC voltage (DC+, DC-) while the user (MVU of FIG. 2) is connecting the separate type charging connector 200 may be prevented.

For example, the input switch 231 may be implemented as a button push type, the user (MVU of FIG. 2) may press the input switch 231 while connecting the separate type charging connector 200, and the communication path PP may be disconnected while the input switch 231 is pressed. Depending on whether the communication path PP is disconnected, whether the controller 140 performs switching (143) and/or whether the mobility device MV controls the switch MVS may be changed. That is, the body of the separate type charging connector 200 may include a first charging path CC between the charging apparatus 100 and the mobility device MV and the communication paths CP and PP between the charging apparatus 100 and the mobility device MV and whether the communication paths CP and PP are electrically connected may be switched according to the input received by the input switch 231.

For example, the cable connection end 230 may be set to be locked so that it cannot be connected to the separate type charging cable 120 before the input switch 231 receives the input. According to the input of the input switch 231, the separate type charging connector 200 may unlock the lock. That is, the body 220 may switch physical separation between one end 123 of the separate type charging cable 120 and the cable connection end 230 according to the input received by the input switch 231.

Accordingly, safety accidents due to direct current voltage (DC+, DC-) while the user (MVU of FIG. 2) is connecting the separate type charging connector 200 may be prevented, and it may also be effective to implement the connection structure of the cable connection end 230 and the separate type charging cable 120 as a waterproof structure.

For example, the cable connection end 230 may include protruding wires 230P, and one end 123 of the separate type charging cable 120 may include a recessed portion 123R into which the protruding wires 230P are inserted. As the protruding wires 230P are inserted, the one end 123 of the separate type charging cable 120 and the cable connection end 230 may be electrically connected to each other.

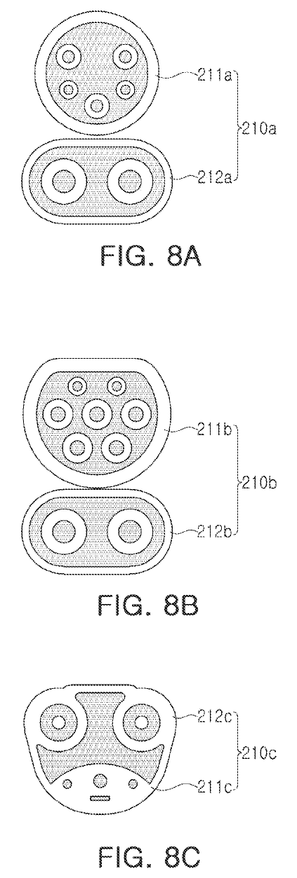

Referring to FIGS. 8A-8C, the mobility connection ends 210a, 210b, and 210c may include first portions 211a, 211b, and 211c and second portions 212a, 212b, and 212c, and the shape and arrangement relationship of the first portions 211a, 211b, and 211c and the second portions 212a, 212b, and 212c may be determined according to one of various standards. That is, the mobility connection ends 210a, 210b, and 210c may be implemented as an outlet of one of various specifications.

The various specifications may be determined to be different by region/country. The charging apparatus (100 of FIG. 1) and method according to an embodiment of the present disclosure may use the separate type charging cable (120 of FIG. 1) from which the separate type charging connector (200 of FIG. 1) is separated, and thus, may not be limited to the required standards of the separate type charging connector (200 of FIG. 1). Therefore, the charging apparatus (100 of FIG. 1) may be widely distributed to various regions/countries by simplifying the specifications, and the cost/time of development/production may be reduced.

Meanwhile, referring to FIG. 9, a controller 500 of the charging apparatus and method using the separate type charging cable according to an embodiment of the present disclosure may be implemented as a computing system including at least one processor 501, a computer-readable storage medium 502, and a communication bus 503. For example, the controller 500 may be implemented as a microcontroller or an embedded system. The storage medium 502 may record one or more programs including instructions for executing a charging method using a separate type charging cable according to an embodiment of the present disclosure. The communication bus 503 may interconnect various other components of the computing device, including the processor 501 and the computer-readable storage medium 502.

The processor 501 may cause the controller 500 to operate according to the embodiment mentioned above. For example, the processor 501 may execute one or more programs stored in the computer-readable storage medium 502. The one or more programs may include one or more computer-executable instructions, which, when executed by the processor 501, may be configured to cause the controller 500 to perform operations according to an embodiment.

The computer-readable storage medium 502 may be configured to store computer-executable instructions, program code, program data, and/or other suitable forms of information. A program 502a stored on the computer-readable storage medium 502 includes a set of instructions executable by the processor 501. In an embodiment, the computer-readable storage medium 502 may be memory (volatile memory, such as random access memory, nonvolatile memory, or a suitable combination thereof), one or more magnetic disk storage devices, optical disk storage devices, flash memory devices, any other form of storage medium that may be accessed by the controller 500 and capable of storing desired information, or a suitable combination thereof.

The controller 500 may also include one or more input/output interfaces 505 providing an interface for one or more input/output devices 504 and one or more network communication interfaces 506. The input/output interface 505 and the network communication interface 506 are connected to the communication bus 503. The network may be one of a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), 5G, Wi-Fi, or another cellular network, and may also be implemented as Ethernet, media oriented systems transport (MOST), Flexray, controller area network (CAN), local interconnect network (LIN), Internet, Bluetooth, near field communication (NFC), Zigbee, radio frequency (RF), etc.

The input/output device 504 may be connected to other components of the controller 500 via the input/output interface 505. The input/output devices 504 may include, for example, input devices, such as pointing devices (a mouse or trackpad), keyboards, touch input devices (a touchpad or a touchscreen), voice or sound input devices, various types of sensor devices and/or imaging devices, and/or output devices, such as display devices, printers, speakers, and/or network cards. For example, the input/output devices 504 may be included within the controller 500 as a component constituting the controller 500 or may be connected to the controller 500 as a separate device distinct from the controller 500.

Meanwhile, the embodiments of the present disclosure may include a program for performing the methods described in this specification on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording media include magnetic media, such as hard disks, floppy disks, and magnetic tapes, optical recording media, such as CD-ROMs, DVDs, and hardware devices specifically configured to store and perform program instructions, such as ROM, RAM, flash memory, etc. Examples of the program may include not only machine language code, such as that generated by a compiler, but also high-level language code that may be executed by a computer using an interpreter or the like.

According to the charging apparatus and method using a separate type charging cable, the separate type charging connector, and the storage medium according to an embodiment of the present disclosure, the user may easily connect the separate type charging cable to the separate type charging connector without manually moving the separate type charging cable when bringing the separate type charging connector into proximity with the charging apparatus for mobility device charging, and inefficiency (e.g., requiring a large force from the user) or instability (e.g., causing a safety accident during movement or causing a safety accident during connection) due to manual movement of the separate type charging cable may be prevented.

For example, although the specifications of the separate type charging connector may be determined to be different depending on the region/country, the charging apparatus and method according to an embodiment of the present disclosure uses a separate type charging cable from which the separate type charging connector is separated, and thus, may not be limited to the required specifications of the separate type charging connector. Therefore, the charging apparatus may be widely distributed to various regions/countries by simplifying the specifications, and the cost/time for development/production of the charging apparatus may be reduced.

While example embodiments have been shown and described above, it will be apparent to those skilled in the art that modifications and variations could be made without departing from the scope of the present disclosure as defined by the appended claims.

1. A charging apparatus comprising:
a charger configured to provide charging power;
a separate type charging cable that is connected to the charger and is configured to transmit the charging power;
a wireless communication unit configured to wirelessly communicate with a separate type charging connector which is configured to be connected to, and separated from, the separate type charging cable; and
a controller configured to control movement of the separate type charging cable to a position based on a wireless communication result of the wireless communication unit.

2. The charging apparatus of claim 1, wherein the controller is further configured to control movement of one end of the separate type charging cable to a position corresponding to coordinates of the separate type charging connector on a ground based on the wireless communication result of the wireless communication unit.

3. The charging apparatus of claim 2, wherein the controller is further configured to control descent of the separate type charging cable so that one end of the separate type charging cable moves to a position corresponding to the coordinates, and then moves toward the ground.

4. The charging apparatus of claim 3, wherein:
the charger includes a charger body disposed on the ground and a ceiling portion forming a layer at one end of the charger body;
the wireless communication unit includes three wireless communication beacons arranged at three different points on the ceiling portion; and
the controller is configured to measure the coordinates based on triangulation of received signal strength indicators of the three wireless communication beacons.

5. The charging apparatus of claim 1, wherein the controller, after controlling the movement of the separate type charging cable, is configured to monitor connection between the separate type charging cable and the separate type charging connector, and to control a switch which determines whether the charger provides the charging power to the separate type charging cable according to a change in a connection monitoring result.

6. The charging apparatus of claim 1, wherein the separate type charging cable includes a first charging path for charging a battery within a mobility device, and a second charging path for charging a battery within the separate type charging connector.

7. The charging apparatus of claim 6, further comprising:
the separate type charging connector;
wherein the separate type charging connector includes:
a mobility connection end configured to be connected to, and separated from, the mobility device;
a cable connection end configured to be connected to, and separated from, one end of the separate type charging cable; and
a body including a battery in the separate type charging connector and electrically connecting the mobility connection end and the cable connection end;
wherein the body includes a wireless communication module configured to receive operating power from the battery in the separate type charging connector, and to wirelessly communicate with the wireless communication unit.

8. The charging apparatus of claim 7, wherein the separate type charging connector further includes an input switch positioned at the cable connection end and configured to receive an input, and wherein the body is configured to switch whether to electrically connect one end of the separate type charging cable to the cable connection end according to the input received by the input switch.

9. The charging apparatus of claim 8, wherein the body is configured to physically separate one end of the separate type charging cable and the cable connection end according to the input received by the input switch.

10. A separate type charging connector comprising:
a mobility connection end configured to be connected to and separated from a mobility device;
a cable connection end configured to be connected to and separated from one end of a separate type charging cable of a charging apparatus; and
a body electrically connected between the mobility connection end and the cable connection end;
wherein the body includes a wireless communication module configured to wirelessly communicate with the charging apparatus.

11. The separate type charging connector of claim 10, wherein the body further includes a battery electrically connected to the cable connection end, and
wherein the battery is configured to provide operating power to the wireless communication module.

12. The separate type charging connector of claim 11, wherein the wireless communication module of the body is configured to wirelessly communicate with the charging apparatus to support measurement of a received signal strength indicator for the body of the charging apparatus.

13. The separate type charging connector of claim 10, further comprising an input switch disposed at the cable connection end and configured to receive an input, wherein the body is configured to switch whether to electrically connect one end of the separate type charging cable and the cable connection end according to the input received by the input switch.

14. The separate type charging connector of claim 13, wherein the body is configured to physically separate one end of the separate type charging cable and the cable connection end according to the input received by the input switch.

15. The separate type charging connector of claim 13, wherein the body includes a first charging path between the charging apparatus and the mobility device and a communication path between the charging apparatus and the mobility device and is configured to switch whether to electrically connect the communication path according to the input received by the input switch.

16. A charging method using a separate type charging cable, the charging method comprising:
measuring, by a wireless connection unit, a position of a separate type charging connector by wirelessly communicating with the separate type charging connector which is either connected to or separated from a separate type charging cable;
controlling, by a controller, movement of the separate type charging cable to the position of the separate type charging connector;
charging, by a charger, a mobility device; and
controlling charging, by the controller, of the mobility device after the separate type charging connector is electrically connected between the separate type charging cable and the mobility device.

17. The charging method of claim 16, wherein the measuring includes measuring coordinates of the separate type charging connector on a ground based on triangulation of received signal strength indicators of three wireless communication beacons arranged at three different points on the wireless connection unit.

18. The charging method of claim 17, wherein the controlling of the movement includes controlling the movement of one end of the separate type charging cable to a position corresponding to the coordinates, and controlling descent of the separate type charging cable so that the one end of the separate type charging cable is moves toward the ground after moving to the position corresponding to the coordinates.

19. The charging method of claim 18, wherein controlling charging includes monitoring a connection between the separate type charging cable and the separate type charging connector after controlling the movement of the separate type charging cable, and controlling switching of a manner of charging of the mobility device according to a change in a connection monitoring result.

20. A storage medium on which one or more programs including instructions for executing the charging method using a separate type charging cable according to claim 16 are recorded.
